(19) United States
(12) Patent Application Publication
(10) Pub. No.: US 2022/0113944 A1
(43) Pub. Date: Apr. 14, 2022

(54) ARITHMETIC PROCESSING DEVICE

(71) Applicant: OLYMPUS CORPORATION, Tokyo (JP)

(72) Inventor: Hideaki Furukawa, Akiruno-shi (JP)

(73) Assignee: OLYMPUS CORPORATION, Tokyo (JP)

(21) Appl. No.: 17/558,783

(22) Filed: Dec. 22, 2021

Related U.S. Application Data
(63) Continuation of application No. PCT/JP2019/039897, filed on Oct. 9, 2019.

(51) Int. Cl. G06F 7/57; G06F 17/15

(52) U.S. Cl. CPC G06F 7/57; G06F 17/15

(57) ABSTRACT

In an arithmetic processing device, a controller includes: a second non-linear converter that, when a selector has branched off to a second processing side, performs non-linear arithmetic processing on the result of a cumulative addition processing of a first adder; and a second pooling processing part to which the results of the cumulative addition processing of k first adders that have been subject to the non-linear arithmetic processing by the second non-linear converter are inputted, the second pooling processing part performing a pooling process on the simultaneously inputted data. A data-storing memory manager writes the same data to k different data-storing memories when the number of input feature map data is less than or equal to N/k. The controller performs a control so that the selector branches off to the second processing side when the number of input feature map data is less than or equal to N/k.

### CROSS-REFERENCE TO RELATED APPLICATIONS

This application is a continuation application based on a PCT Patent Application No. PCT/JP2019/039897, filed on Oct. 9, 2019, the entire content of which is hereby incorporated by reference.

### BACKGROUND

### Technical Field

The present invention relates to an arithmetic processing device, more specifically a circuit configuration of an arithmetic processing device that performs deep learning using a convolutional neural network.

### Background Art

Conventionally an arithmetic processing device is known that performs arithmetic processing using a neural network in which a plurality processing layers are hierarchically connected. In particular, in arithmetic processing devices that perform image recognition, deep learning using a convolutional neural network (hereinafter referred to as CNN) is widely performed.

FIG. 28 is a diagram showing a flow of image recognition processing by deep learning using CNN. In image recognition by deep learning using CNN, the input image data (pixel data) is sequentially processed in a plurality of processing layers of CNN, so that the final arithmetic result data in which the object included in the image is recognized is obtained.

The processing layer of CNN is roughly classified into a convolution layer and a full-connect layer. The convolution layer performs a convolution processing including convolution calculation processing, non-linear arithmetic processing, reduction processing (pooling processing), and the like. The fill-connect layer performs a full-connect processing in which all inputs (pixel data) are multiplied by the filter coefficient to perform cumulative addition. However, there are also convolutional neural networks that do not have a full-connect laver.

Image recognition by deep learning using CNN is performed as follows. First, image data is subjected to a combination of a convolution calculation processing (combination processing), which generates a feature map (FM) by extracting a certain area and multiplying it by multiple filters with different filter coefficients, and a reduction processing (pooling process), which reduces a part of the feature map, as one processing layer, and this is performed a plurality of times (in a plurality of processing layers). These processes are the processes of the convolution layer.

The pooling processing has variations such as max polling in which the maximum value of the neighborhood 4 pix is extracted and reduced to ½×½, and average polling in which the average value of the neighborhood 4 pix is obtained (not extracted).

FIG. 29 is a diagram showing a flow of convolution processing. First, one pixel and pixels in the vicinity thereof (8 pixels in the vicinity in the example of FIG. 29) are extracted from the image data, each pixel is subjected to filter processing having different filter coefficients (convolution processing), and all of them are cumulatively added to obtain data corresponding to one pixel. By performing non-linear conversion and reduction processing (pooling processing) on the generated data and performing the above processing on all pixels of the image data, an output feature map (oFM) is generated for one surface. By repeating this a plurality of times, a plurality of surfaces of oFM are generated. In an actual circuit, all of the above is subjected to a pipeline processing.

Further, the above-described convolution processing is repeated by using the output feature amount map (oFM) as an input feature amount map (iFM) for next processing to perform filter processing having different filter coefficients. In this way, the convolution processing is performed a plurality of times to obtain an output feature amount map (oFM).

When the convolution processing progresses and the FM is small-sized to a certain extent, the image data is read as a one-dimensional data string. The full-connect processing, in which each data in the one-dimensional data string is multiplied by a different coefficient and cumulatively added, is performed a plurality of times (in a plurality of processing layers). These processes are the processing of the full-connect layer.

Then, after the full-connect processing, the probability that the object included in the image is detected (the probability of subject detection) is output as the subject estimation result as the final arithmetic result. In the example of FIG. 28, as the final arithmetic result data, the probability that a dog was detected was 0.01 (1%), the probability that a cat was detected was 0.04 (4%), the probability that a boat was detected was 0.94 (94%), and the probability that a bird was detected was 0.02 (2%).

In this way, image recognition by deep learning using CNN can realize a high recognition rate. However, in order to increase the types of subjects to be detected and to improve the subject detection accuracy, it is necessary to increase the network. Then, a data-storing buffer and a filter coefficient-storing buffer inevitably have a large capacity, but the ASIC (Application-Specific integrated Circuit) cannot be equipped with a very large capacity memory.

Further, in deep learning in image recognition processing, the relationship between the FM (Feature Map) size and the number of FMs (the number of FM surfaces) in the (K−1) layer and the Kth layer may be as shown in the following equation. In many cases, it is difficult to optimize when determining the memory size as a circuit.

FM size [K]=¼×FM size [K−1]

FM number [K]=2×FM number [K−1]

For example, when considering the memory size of a circuit that can support Yoro_v2, which is one of the variations of CNN, about 1 GB is required if it is determined only by the FM size and the maximum value of the FM number. Actually since the number of FMs and the FM size are inversely proportional to each other, a memory of about 3 MB is sufficient for calculation. However, for an ASIC mounted on a battery-powered mobile device, there is a need to reduce power consumption and chip cost as much as possible. Therefore, it is necessary to make the memory as small as possible.

Due to such problem, CNN is generally implemented by software processing using a high-performance PC or GPU (Graphics-Processing Unit). However, in order to realize high-speed processing, it is necessary to configure a heavy-processing part with hardware. An example of such a hardware implementation is described in Optimizing FPGA-based Accelerator Design for Deep Convolutional Neural Networks, Proceedings of the 2015 ACM/SIGDA International Symposium on Field-Programmable Gate Arrays, February 2015, Pages 161-170 (hereinafter referred to as Non-Patent Document 1). Non-Patent Document 1 discloses an accelerator for deep CNN based on an FPGA (Field-Programmable Gate Array) platform.

In the shallow layer of CNN, the number of iFMs (the number of iFM surfaces) may be extremely smaller than the input parallelism degree N of the circuit. In this case, it is conceivable to reduce the power consumption by shutting off the power supply so that the unused circuit does not operate. However, since deep learning is a very heavy process, it is more effective to shorten the processing time by utilizing the mounted circuit as much as possible.

Non-Patent Document 1 describes an example in which the number of iFMs in the first layer is 3, while the number of the FPGA configurations is 7. Non-Patent Document 1 does not specifically mention how to operate it, but if only 3 FPGA configurations out of the 7 FPGA configurations are used, more than half of the mourned circuits are not working.

Regarding the output side, Non-Patent Document 1 describes an example in which the number of oFMs in the second layer is 20, while the number of the FPGA configuration is 64. There is no specific mention of how to operate it, but if only 20 FPGA configurations out of the 64 FPGA configurations are used, it means that more than two-thirds of the mounted circuits are not working.

In the pooling process, for example, in the case of 2×2 maximum value pooling processing, only one maximum value is extracted from the four input data. As a result, the data rate is reduced to ¼, and the FM size after processing is halved vertically and horizontally. However, depending on the setting, the same position data may be duplicated, and as a result, the data rate may not change and the FM size may not change. If this is processed uniformly in the same manner as other layers, the processing time in the arithmetic part will be quadrupled, which will be a problem in performing high-speed processing such as for moving images. Non-Patent Document 1 does not mention measures against such a speed reduction.

### SUMMARY

The present invention provides an arithmetic processing device that shortens the processing time by enabling parallel processing to execute data required for executing pooling processing, in an arithmetic processing device that performs deep learning using a convolutional neural network.

An aspect of the present invention is an arithmetic processing device for deep learning that performs a convolution processing and a full-connect processing. The arithmetic processing device includes a processor that functions as: a data-storing memory manager having a data-storing memory configured to store input feature amount map data and a data-storing memory controller configured to manage and control the data-storing memory; a filter coefficient-storing memory manager having a filter coefficient-storing memory configured to store a filter coefficient and a filter coefficient-storing memory controller configured to manage and control the filter coefficient-storing memory an external memory configured to store the input feature map data and output feature map data; a data input part configured to acquire the input feature amount map data from the external memory; a filter coefficient input part configured to acquire the filter coefficient from the external memory an arithmetic part with a configuration in which N-dimensional data is input, processed in parallel, and M-dimensional data is output (where N and M are positive numbers greater than 1), configured to acquire the input feature map data from the data-storing memory, acquire the coefficient from the coefficient-storing memory, and perform a filter processing, a cumulative addition processing, a non-linear arithmetic processing, and a pooling processing; a data output part configured to convert the M-dimensional data output from the arithmetic part to output as output feature map data to the external storing memory; and a controller configured to control the arithmetic processing device. The arithmetic part functions as a filter arithmetic part, configured to perform a filter arithmetic on the N-dimensional data in parallel, k first adders configured to cumulatively add N/k arithmetic results of the filter arithmetic part, a selector provided after each first adder, the selector being configured to branch output of the first adder and to switch between a first processing side and a second processing side, a second adder configured to cumulatively add cumulative addition results of k first adders in a case where the selector branches to the first processing side, a third adder configured to cumulatively add cumulative addition results of the second adder in a subsequent stage, a first non-linear converter configured to perform non-linear arithmetic processing on cumulative addition results of the third adder, a first pooling processing part configured to perform pooling processing on processing results of the first non-linear converter, a second non-linear converter configured to perform non-linear arithmetic, processing on cumulative addition results of the first adder in a case where the selector branches to the second processing side, a second pooling processing part configured to input cumulative addition results of the k first adders that have been non-linearly processed by the second non-linear converter and to perform pooling processing on simultaneously input data, and an arithmetic controller configured to control the arithmetic part. In a case where the number of the input feature amount map data input to the arithmetic, part≤N/k, the data-storing memory manager is configured to write the same data to k different data storage memories. In a case where the number of the input feature amount map data≤N/k, the arithmetic controller is configured to control the selector to branch to the second processing side.

In the first mode, the data storage memory controller may be configured to control to write the same data to the same address of k different data storage memories when writing to the data storage memory, and to classify the data storage memory into k groups of N/k, to control to access addresses that are vertically and/or horizontally offset by several pixels by changing the addresses in each group at a time of reading from the data storage memory.

In the second mode, the data storage memory controller may be configured to control to write the same data to addresses that are shifted by several pixels in the vertical and/or horizontal directions in k different data storage memories at a time of writing to the data storage memory, and to access all the data storage memories at the same address at a time of reading from the data storage memory.

An aspect of the present invention is as arithmetic processing device for deep learning that performs a convolution processing and a fall-connect processing. The arithmetic processing device includes a processor that functions as: a data-storing memory manager having a data-storing memory configured to store input feature amount map data and a data-storing memory controller configured to manage and control the data-storing memory; a filter coefficient-storing memory manager having a filter coefficient-storing memory configured to store a filter coefficient and a filter coefficient-storing memory controller configured to manage and control the filter coefficient-storing memory; an external memory configured to store the input feature map data and output feature map data; a data input part configured to acquire the input feature amount map data from the external memory; a filter coefficient input part configured to acquire the filter coefficient from the external memory; an arithmetic part with a configuration in which N-dimensional data is input, processed in parallel, and M-dimensional data is output (where N and M are positive numbers greater than 1), configured to acquire the input feature map data from the data-storing memory, acquire the coefficient from the coefficient-storing memory, and perform a filter processing, a cumulative addition processing, a non-linear arithmetic processing, and a pooling processing; a data, output part configured to convert the M-dimensional data output from the arithmetic part to output as output feature map data to the external storing memory; and a controller configured to control the arithmetic processing device. The arithmetic part functions as a filter arithmetic part configured to perform a filter arithmetic on the N-dimensional data in parallel, k first adders configured to cumulatively add N/k arithmetic results of the filter arithmetic part, a selector provided after each first adder, the selector being configured to branch output of the first adder and to switch between a first processing side and a second processing side, a second adder configured to cumulatively add cumulative addition results of k first adders in a case where the selector branches to the first processing side, a third adder configured to cumulatively add cumulative addition results of the second adder in a subsequent stage, a first non-linear converter configured to perform non-linear arithmetic processing on cumulative addition results of the third adder, a first pooling processing part configured to perform pooling processing on processing results of the first non-linear converter, a second pooling processing part configured to perform pooling processing on cumulative addition results of the first adder when the selector branches to the second processing side, a second non-linear converter provided after the second pooling processing part, the second non-linear converter being configured to perform non-linear arithmetic processing on cumulative addition results of the first adder that has been subjected to the pooling processing by the second pooling processing part, and an arithmetic controller configured to control the arithmetic part. In a case where the number of the input feature amount map data, input to the arithmetic part≤N/k, the data-storing memory manager is configured to write the same data to k different data storage memories. In a case where the number of the input feature amount map data≤N/k, the arithmetic controller is configured to control the selector to branch to the second processing side.

The first non-linear converter and the second linear converter may have the same configuration and are shared by the first processing side and the second processing side.

The second pooling processing part may be configured to perform pooling processing separately in a vertical direction and a horizontal direction with respect to a scanning direction. A pooling processing in the vertical direction and a pooling processing in the horizontal direction may be each executed at a timing when a trigger signal is input. The arithmetic controller may be configured to output the trigger signal at a preset timing.

According to the arithmetic processing device of each aspect of the present invention, in an arithmetic processing device that performs deep learning using a convolutional neural network, the processing time can be shortened by enabling the data required fire executing the pooling process to be executed in parallel processing.

### BRIEF DESCRIPTION OF THE DRAWINGS

FIG. 1 is an image diagram of obtaining an output feature amount map (oFM) from an input feature amount map (iFM) by a convolution processing.

FIG. 2 is a block diagram showing an overall configuration of an arithmetic processing device according to an embodiment of the present invention.

FIG. 3 is a diagram showing a configuration of an arithmetic part of an arithmetic processing device according to a first embodiment of the present invention.

FIG. 4 is a diagram showing an image of a pooling processing.

FIG. 5 is a diagram showing a configuration of an arithmetic part of an arithmetic processing device according to a modified example of the first embodiment of the present invention.

FIG. 6 is a diagram showing a configuration of an IBUF (data storage memory) manager of the arithmetic processing device according to the first embodiment of the present invention.

FIG. 7 is a diagram showing in detail a “we” generation portion of the IBUF manager of the arithmetic processing device according to the first embodiment of the present invention.

FIG. 8 is a diagram showing a relationship between an input and an output of a non-linear converter when the non-linear conversion is a monotonically increasing function.

FIG. 9 is a diagram showing a configuration of an arithmetic part of the arithmetic processing device according to the modified example of the first embodiment of the present invention.

FIG. 10 is a diagram showing a configuration of an arithmetic part of the arithmetic processing device according to the modified example of the first embodiment of the present invention.

FIG. 11 is a diagram showing a configuration of a first pooling processing part of the arithmetic part of the arithmetic processing device according to the modified example of the first embodiment of the present invention.

FIG. 12 is a diagram showing in detail a “we” generation portion of the IBUF manager of the arithmetic processing device according to the modified example of the first embodiment of the present invention.

FIG. 13A is a diagram showing an iFM processing in a normal pooling processing.

FIG. 13B is a diagram showing an iFM processing in the pooling processing of the sixth layer of Yoro_tiny_v2.

FIG. 14 is a diagram showing a configuration of a first pooling processing part of an arithmetic processing device according to a second embodiment of the present embodiment.

FIG. 15 is a diagram showing a pixel image of FM after non-linear conversion processing.

FIG. 16 is a diagram showing an execution waveform of the first pooling processing part when the operation direction is horizontal in normal pooling processing.

FIG. 17 is a diagram showing an execution waveform of the second pooling processing part when the operation direction is horizontal when stride=1.

FIG. 18 is a diagram showing an execution waveform of a first pooling processing part of the arithmetic processing device according to the second embodiment of the present embodiment.

FIG. 19 is an image diagram in which one oFM is generated by sharing two output channel groups in an arithmetic processing device according to a third embodiment of the present embodiment.

FIG. 20 is a diagram showing a configuration on the output side of the IBUF manager of the arithmetic processing device according to the third embodiment of the present embodiment.

FIG. 21 is a diagram showing a data storage image in DBUFodd and DBUFeven of the IBUF manager of the arithmetic processing device according to the third embodiment of the present embodiment.

FIG. 22 is a diagram showing an image of a difference in position on an iFM processed by two output channel groups in the arithmetic processing device according to the third embodiment of the present embodiment.

FIG. 23A is an image diagram of oFM data output from the arithmetic part during normal processing.

FIG. 23B is an image diagram of oFM data output from the arithmetic part when one oFM is processed by dividing a line among two output channel groups.

FIG. 24 is a diagram showing a flow from a processing of the k-th layer to a processing of the (k+1)-th layer during the normal processing.

FIG. 25 is a diagram showing a flow from a processing of the k-th layer to a processing of the (k+1)-th layer dining the line-Sharing processing.

FIG. 26A is a diagram showing an image of writing specific data to IBUF during line-sharing processing.

FIG. 26B is a diagram showing an image of writing specific data to IBUF at the time of area-sharing processing.

FIG. 27 is a diagram showing an overall configuration of an IBUF manager of the arithmetic processing device according to the third embodiment of the present embodiment.

FIG. 28 is a diagram showing a flow of image recognition processing by deep. learning using CNN.

FIG. 29 is a diagram showing a flow of convolution processing according to the prior art.

### DETAILED DESCRIPTION OF THE PREFERRED EMBODIMENTS

An embodiment of the present invention will be described with reference to the drawings. First, the background of adopting the configuration of the embodiment of the present invention will be described.

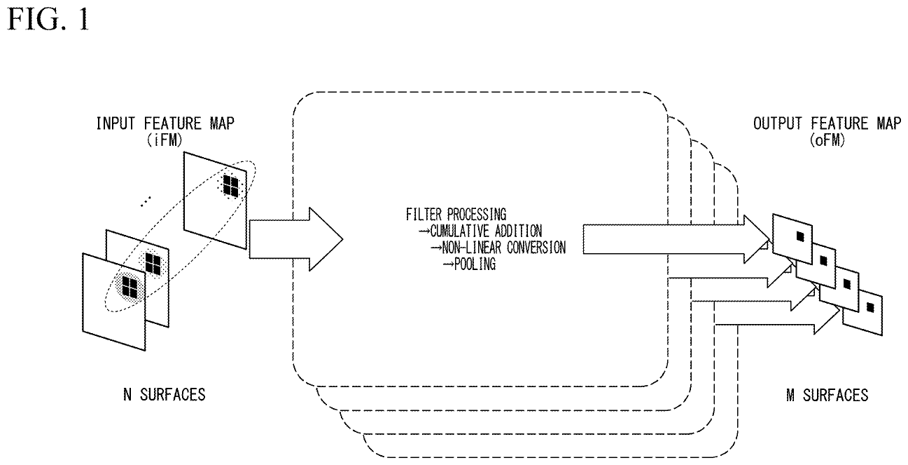

FIG. 1 is an image diagram of obtaining an output feature map (oFM) from an input feature map (iFM) by convolution processing. OFM is obtained by subjecting iFM to processing such as filter processing, cummulative addition, non-linear conversion, and pooling (reduction). As the information required to calculate one pixel of oFM, information (iFM data and filter coefficients) of all pixels in the vicinity of the iFM coordinates corresponding to the output (1 pixel of oFM) is required.

In the convolution processing input is N parallel (N is a positive number of 1 or more), that is, the number of iFM (the number of faces of iFM)=N, and N-dimensional input data is processed in parallel (input N parallel). Also, output is M parallel (M is a positive number of 1 or more), that is, the number of oFM (the number of faces of oFM)=M, and M-dimensional data is output in parallel (output M parallel).

### First Embodiment

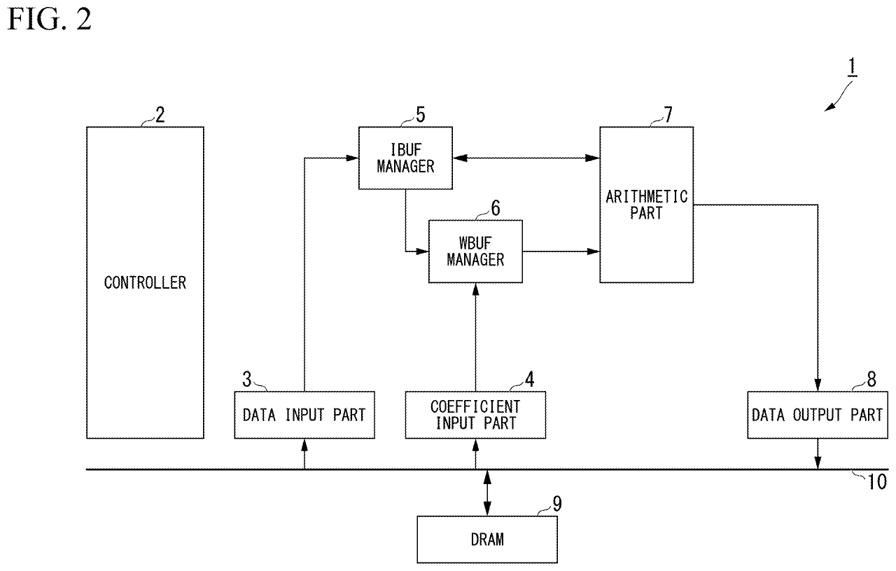

Next, the first embodiment of the present invention will be described with reference to the drawings. FIG. 2 is a block diagram showing an overall configuration of the arithmetic processing device according to the present embodiment. The arithmetic processing device 1 includes a controller 2, a data input part 3, a filter coefficient input part 4, an BRIT (data-storing memory) manager 5, a WBUF (filter coefficient-storing memory) manager 6, an arithmetic part (arithmetic block) 7, and a data output part 8. The data input part 3, the filter coefficient input part 4, and the data output part 8 are connected to the DRAM (external memory) 9 via the bus 10. The arithmetic processing device 1 generates an output feature map (oFM) from the input feature map (iFM).

The IBUF manager 5 has a memory for storing input feature amount map (iFM) data (data-storing memory, IBUF) and a management/control circuit for the data-storing memory (data-storing memory control circuit). Each IBUF is composed of a plurality of SRAMs.

The IBUF manager 5 counts the number of valid data in the input data (iFM data converts it into coordinates, further converts it into an IBUF address (address in IBUF), stores the data in the data-storing memory, and at the same time, acquires the iFM data from the IBUF by a predetermined method.

The WBUF manager 6 has a memory for storing the filter coefficient (filter coefficient-storing memory, WBUF) and a management/control circuit for the filter coefficient-storing memory (filter coefficient-storing memory control circuit). The WBUF manager 6 refers to the status of the IBUF manager 5 and acquires the filter coefficient, which corresponds to the data acquired from the IBUF manager 5, from the WBUF.

The DRAM 9 stores iFM data, oFM data, and filter coefficients. The data input part 3 acquires an input feature amount map (iFM) from the DRAM 9 by a predetermined method and transmits it to the IBUF (data-storing memory) manager 5. The data output part 8 writes the output feature amount map (oFM) data to the DRAM 9 by a predetermined method. Specifically, the data output part 8 concatenates the M parallel data output from the arithmetic part 7 and outputs the data to the DRAM 9. The filter coefficient input part 4 acquires the filter coefficient from the DRAM 9 by a predetermined method and transmits it to WBUF (filter coefficient-storing memory) manager 6.

The arithmetic part 7 acquires data from the IBUF (data-storing memory) manager 5 and filter coefficients from the WBUF (filter coefficient-storing memory manager 6, and performs data processing such as filter processing, cumulative addition, non-linear calculation, and pooling processing. The data (cumulative addition result) subjected to data processing by the arithmetic part 7 is stored in the DRAM 9 via the data output part 8. The controller 2 controls the entire circuit.

In CNN, processing for a required number of layers is repeatedly performed in a plurality of processing layers. Then, the arithmetic processing device 1 outputs the subject estimation result as the final output data, and obtains the subject estimation result by processing the final output data using a processor (or a circuit).

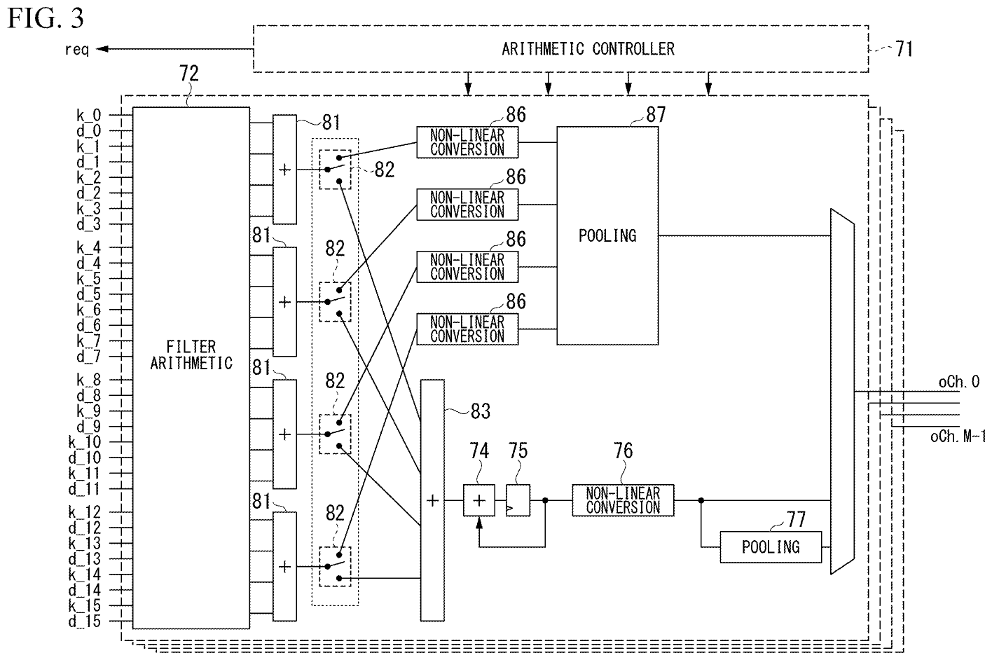

FIG. 3 is a diagram showing a configuration of the arithmetic part 7 of the arithmetic processing device according to the present embodiment. The number of input channels of the arithmetic part 7 is N (N is a positive number of 1 or more), that is, the input data (iFM data) is N-dimensional, and the N-dimensional input data is processed in parallel (input N parallel). The number of output channels of the arithmetic part 7 is M (M is a positive number of 1 or more), that is, the output data is M-dimensional, and the M-dimensional input data is output in parallel (output M parallel).

In one layer (surface), iFM data (d_0 to d_N-1) and filter coefficients (k_0 to k_N-1) are input and one oFM data is output. This process is performed in parallel with the M layer (M surface), and M oFM data (oCh_0 to oCh_M-1) are output.

As described above, the arithmetic part 7 has a configuration in which the number of input channels is N, the number of output channels is M, and the degree of parallelism is N×M. Since the sizes of the number of input channels N and the number of output channels M can be set (changed) according to the size of the CNN, they are appropriately set in consideration of the processing performance and the circuit scale.

In this embodiment, the speed of arithmetic processing is increased by utilizing an inactive circuit in a case where the number of iFMs actually input to the arithmetic part 7 is smaller than the number of input channels N that can be calculated by the arithmetic part 7. Here, for the sake of clarity, description will be made under the following conditions.
Input parallelism N=16
Output parallelism M=16
Number of iFM=3 (3 surfaces of RGB)
Number of oFM=16.
Filter size 3×3
Unit of pooling execution (pooling size) k=2×2

In this case, when one channel group tries to process one iFM, 13 channels out of 16 input channels will be inactive. Accordingly, it is considered to effectively use the inactive circuit.

The arithmetic part 7 includes an arithmetic controller 71 that controls each unit in the arithmetic part. Further, the arithmetic part 7 includes a filter arithmetic part 72, k first adders 81, a selector 82, a second adder 83, a third adder 74, an FF (flip-flop) 75, a first non-linear arithmetic processing part 76, a first pooling processing part 77, a second non-linear arithmetic processing part 86, and a second pooling processing part 87 for each layer (surface). Exactly the same circuit exists for each layer (surface), and there are M such layers (surfaces).

When the arithmetic controller 71 issues a request to the previous stage of the arithmetic part 7, predetermined data is input to the filter arithmetic part 72. The filter arithmetic part 72 is internally configured so that the multiplier and the adder can be operated simultaneously in N parallel, performs a filter processing on the input data, and outputs the result of the filter processing in N parallel.

Each of the first adders 81 cumulatively adds results of N/k filter processing in the filter arithmetic part 72. In the example of FIG. 3, since N=16 and k=4, each of the first adders 81 cumulatively adds results of 16/4=4 filter processing.

A selector 82 is provided after the first adder 81, and branches and switches the output of the first adder 81. The switching condition depends on which of the iFM number and N/k input to the arithmetic part is larger. In the example of FIG. 3, there are k selectors 82 corresponding to each first adder 81, but the output of the first adder 81 may be configured to be commonly switched by one selector 82.

When the number of iFMs>N/k, the arithmetic controller 71 sets and controls to switch the selector 82 so as to perform normal processing (first processing). Specifically, the selector 82 is switched so that the output of the first adder 81 is input to the second adder 83. The second adder 83 cumulatively adds the input results of the cumulative addition processing of the k first adders 81. That is, during normal processing, the first adder 81 divides N (16 in FIG. 3) input channels into k (4 in FIG. 3) to perform the first addition, and the second adder 83 adds all the inputs in the second addition.

The third adder 74 cumulatively adds the result of the cumulative addition process of the second adder 83, which is input in a time division manner, at a subsequent stage. An FF75 for holding the result of cumulative addition is provided in the subsequent stage of the third adder 74.

The non-linear arithmetic processing part 76 performs non-linear arithmetic processing by an Activate function or the like on the result of cumulative addition in the second adder 74 and FF75. The specific implementation is not specified, but for example, non-linear arithmetic processing is performed by polygonal line approximation.

The pooling processing part 77 performs pooling processing such as selecting and outputting (Max Pooling) the maximum value from a plurality of data input from the non-linear arithmetic processing part 76, calculating the average value (Average Pooling), and the like. The processing in the non-linear arithmetic processing part 76 and the pooling processing part 77 can be omitted by the arithmetic controller 71.

When the number of iFMs≤N/k, the arithmetic controller 71 sets and controls to switch the selector 82 so as to perform parallel processing (second processing). Here, the parallel processing refers to a process of executing the data necessary for executing the pooling processing in parallel with the normal processing by utilizing the non-working circuit. As a result, the processing time can be shortened and the arithmetic processing can be speeded up. When parallel processing is selected, the selector 82 is switched so that the output of the first adder 81 is input to the second non-linear converter 86.

The second non-linear converter 86 performs non-linear conversion (non-linear arithmetic processing) such as an Activate function on the result of the cumulative addition processing of k first adders 81. The second pooling processing part 87 inputs the results of the cumulative addition processing of k first adders 81, which have been non-linearly processed by the second non-linear converter 86, and performs pooling processing on the simultaneously input data.

That is, When the number of iFMs is small, the output of the first adder 81 is transmitted to the parallel processing side, individual non-linear conversion is performed, and then the pooling processing of simultaneous input of k data (4 in FIG. 3) is executed. In the pooling processing, in the case of mean value pooling, input data is added and divided by k (4 in FIG. 3) (2-bit shift), and in the case of max pooling, the maximum value is acquired.

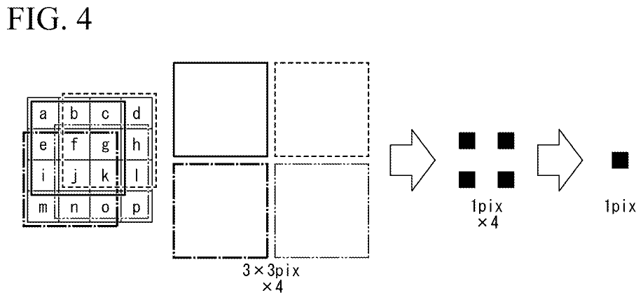

FIG. 4 is a diagram showing an image of the pooling processing. When the input data is 4×4 pixels and the filter size is 3×3 pixels, the filter processing generates four pieces of 3×3 pixel data. When the pooling execution unit k=2×2, the four data after the filtering processing are collected and the pooling processing is executed once. Therefore, if four (generally k) data can be calculated at the same time, the processing time can be shortened and the calculation processing can be speeded up. According to the configuration of FIG. 3 described above, since there are four (generally k) second non-linear converters 86, the data necessary for executing the pooling processing can be executed in parallel with the normal processing. Therefore, when the input channel is free, the data generation required for pooling can be executed at once in parallel with the normal processing.

### Modification Example

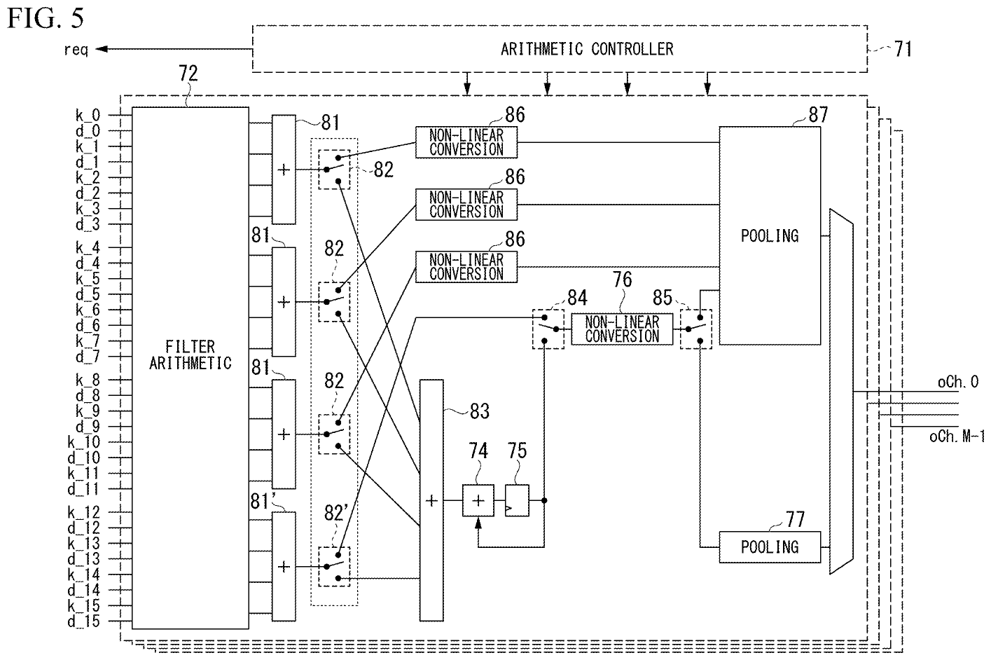

Since the upper side (parallel processing side) and the lower side (normal processing side) of FIG. 3 are exclusively used, the first non-linear converter 76 may have a configuration to be used as the second non-linear converter 86 by switching with the selector 82. FIG. 5 is a diagram showing the configuration of such an arithmetic part 7.

One of the four selectors 82 (selector 82′) is connected to the input of the first non-linear converter 76 via the selector 84. The output of the first non-linear converter 76 is connected to the selector 85 so that the output destination can be selected from the first pooling processing part 77 and the second pooling processing part 87.

When the number of iFMs>N/k, the arithmetic controller 71 sets and controls to switch the selector 82 so as to perform the normal processing (first processing). That is, the selector 82 is switched so that the output of the first adder 81 is input to the second adder 83. The second adder 83 cumulatively adds the results of the cumulative addition processing of the k fist adders 41 that have been input. The third adder 74 cumulatively adds the result of the cumulative addition process of the second adder 83, which is input in a time division manner, at a subsequent stage. An FF75 for holding the result of cumulative addition is provided in the subsequent stage of the third adder 74.

A selector 84 is provided between the FF 75 and the first non-linear converter 76, and the input of the first non-linear converter 76 can be switched between the normal processing side and the parallel processing side. In the case of normal processing, the first non-linear converter 76 performs non-linear arithmetic processing by an Activate function or the like on the result of cumulative addition in the third adder 74 and FF75.

A selector 85 is provided after the first non-linear converter 76, and the output of the first non-linear converter 76 can be switched between the normal processing side and the parallel processing side. In the case of normal processing, the data processed by the first non-linear converter 76 is input to the first pooling processing part 77. The first pooling processing part 77 performs the pooling processing, such as selectively outputting the maximum value (maximum value pooling) from a plurality of data input from the first non-linear converter 76, calculating the average value (average value pooling), and the like.

When the number of iFMs=N/k, the arithmetic controller 71 sets and controls to switch the selector 82 so as to perform parallel processing (second processing). That is, the selector 82 is switched so that the output of the first adder 81 is input to the second non-linear converter 86. At this time, one of the four selectors 82 (selector 82′) is connected to the input of the first non-linear converter 76 via, the selector 84. That is, the output of one of the four first adders 81 (first adder 81′) is input to the first non-linear converter 76.

The second non-linear converter 86 performs non-linear conversion (non-linear arithmetic processing) such as an Activate function on the result of the cumulative addition processing of (k−1) pieces (three in FIG. 5) of the first adder 81. At the same time, the first non-linear converter 76 performs non-linear conversion (non-linear arithmetic processing) such as an Activate function on the result of the cumulative addition processing of the first adder 81′. Then, the selector 85 is switched so that the output of the first non-linear converter 76 is input to the second pooling processing part 87.

The second pooling processing part 87 is input the result of the cumulative addition processing of k (4 in FIG. 5) first adders 81 (including first adders 81′) that have been non-linearly processed by the second non-linear converter 86 and the first non-linear converter 76, and performs the pooling processing on the data input at the same time. With such a configuration, the number of the second non-linear converters 86 can be reduced by one, and the circuit configuration can be reduced.

### (Method of Storing/Reading Data in IBUF)

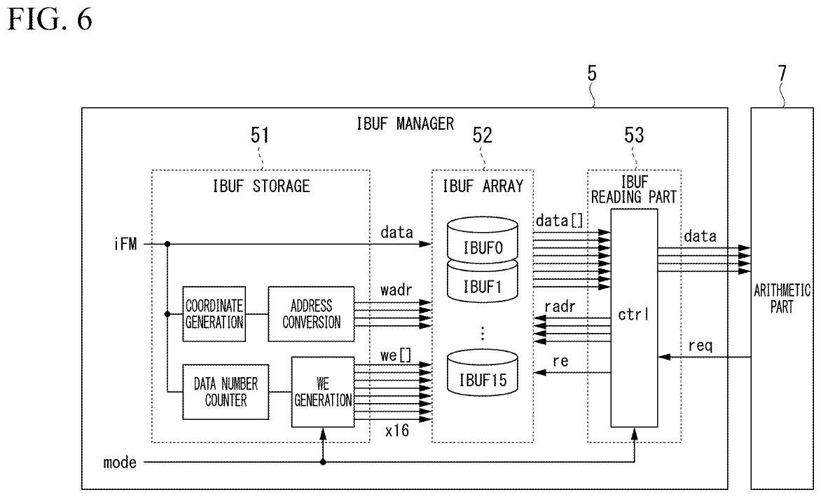

Next, a method of storing/reading data, in the IBUF (data storage memory) in the present embodiment will be described. FIG. 6 is a diagram showing the configuration of the IBUF (data storage memory) manager 5 of the present embodiment.

The IBUF manager 5 includes an IBUF storage 51 that stores data in an IBUT (data storage memory), an IBUF array 52 in which a plurality of IBUFs are arranged, and an IBUF-reading part 53 that reads data from the IBUF. The IBUF storage 51 and the IBUF-reading part 53 are included in the above-mentioned data storage memory controller. In the case of input N parallel, N IBUFs are used. For example, as shown in FIG. 6, when the input parallelism degree N=16, 16 IBUFs (IBUF0 to IBUF15) are used.

When iFM data is input, the IBUF storage 51 counts the number of valid data in the input data and converts it into coordinates (coordinate generation), further converts it into an IBUF address (address conversion), and stores in the IBUF together with the iFM data (data).

The data storage memory controller of the IBUF manager 5 controls writing to the IBUF and reading from the IBUF, and this control has several modes. The following is the control in the case of one mode (first mode). In a case where the number of iFMs≤N/k, the IBUF storage 51 classifies the IBUFs into k groups by N/k, and when writing to the IBUF, writes the same data to the same address of k different IBUFs belonging to different groups.

For example, when N=16 and k=4, the IBUF storage 51 divides the IBUF (IBUF 0 to IBUF 15) into the following four groups.
IBUF 0-3
IBUF 4-7
IBUF 8-11
IBUF 12-15

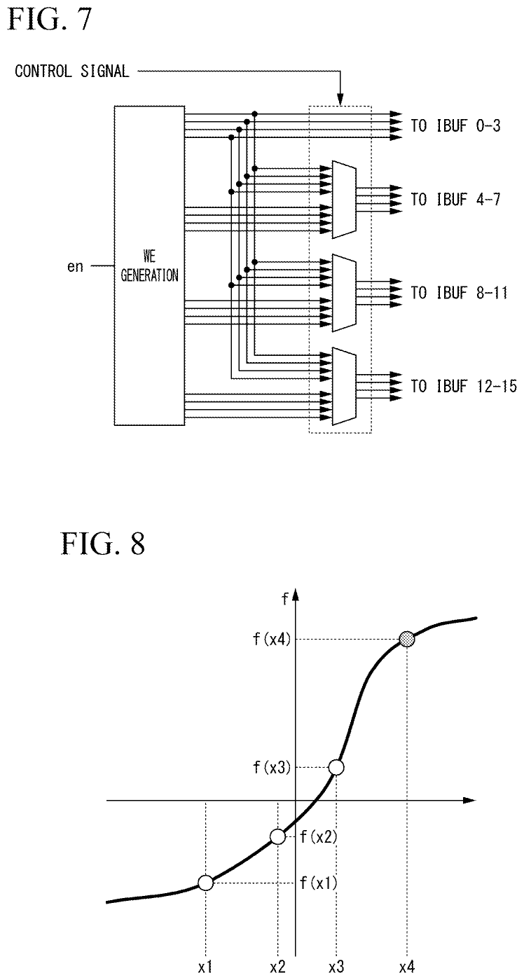

Then, when writing to the IBUF, the IBUF storage 51 writes the same data to the same address of four IBUFs (for example, IBUF 0, IBUF 4, IBUF 8, IBUF 12) belonging to different groups. Writing can be realized by switching the generation of “we” by the mode signal. FIG. 7 is a diagram showing in detail the “we”-generating portion of the IBUF storage 51 of FIG. 6. As a result, the same data as IBUF 0 to 3 is duplicated in IBUF 4 to 7, IBUF 8 to 11, and IBUF 12 to 15.

The IBUF-reading part 53 reads a portion shifted by one pixel (or several pixels) vertically and/or horizontally when reading from the IBUF. This can be achieved by changing the addressing of each group during data access and accessing addresses that are offset by several pixels vertically and or horizontally. For example, by generating one address for each of IBUF 0 to 3, IBUF 4 to 7, IBUF 8 to 11, and IBUF 12 to 15, data can be read from a position shifted by one pixel vertically and/or horizontally as shown on the left of FIG. 4.

### (Modified Example of Data Storage/Reading Method in IBUF)

Another example of a method of storing/reading data in IBUF will be described. This example is the control in the case of a mode (second mode) different from the above-mentioned first mode. When the number of iFMs≤N/k, the IBUF storage 51 classifies IBUF into k groups of N/k each. Then, when writing to the IBUF, the IBUF storage 51 writes the same data in k different IBUFs belonging to different groups to addresses shifted by several pixels (for example, one pixel) vertically and/or horizontally. That is, the data is written so that data shifted by several pixels (for example, one pixel) is stored at the same address in each group.

The IBUF-reading part 53 does not change the access address when reading from the IBUF, and accesses all the IBUFs with the same address. Since it can be read from the same address, reading becomes easier.

The we generation at the time of writing is the same as the above-mentioned example, and the writing address is generated so as to be shifted by one pixel at IBUF 0 to 3, IBUF 4 to 7, IBUF 8 to 11, and IBUF 12 to 15. By doing so, the address at the time of reading can be shared.

The above has been described in the case of 16 parallel inputs, but in a case where the degree of parallelism is higher than that, for example, when the input is 32 parallels, since it is possible to have two sets of 3 ch×4 parallels that can execute pooling processing at one time, it becomes possible to perform calculation at double speed. Alternatively, even if the pooling size becomes 3×3, it can be configured to perform 3×3 pooling in 9 parallels at a time as a configuration of 3 ch×9 parallels.

### (Variation Example of Non-Linear Arithmetic Processing)

The non-linear arithmetic processing is usually a processing part of an activation function such as Sigmoid/ReLU/Tanh, but these are almost always monotonically increasing functions. FIG. 8 is a diagram showing the relationship between the input (x1 to x4) and the output (f(x1) to f(x4)) of the non-linear converter when the non-linear conversion f(x) is a monotonically increasing function.

Consider the case where the pooling process is maximum value pooling. In this case, when pooling the results (f(x1) to f(x4)) after the non-linear arithmetic processing, the maximum f(x4) from f(x1) to f(x4) is output. On the other hand, when the pooling process is performed first and then the non-linear process is performed, the non-linear process is performed on the maximum x4 of x1 to x4, so f(x4) is output. That is, the following equation holds, and the result does not change.

max(f(x1),f(x2),f(x3),f(x4))=f(max(x1,x2,x3,x4))

That is, if the non-linear transformation f is a monotonically increasing function, the maximum value pooling process and the non-linear transformation f can be interchanged. Therefore, if the condition that the non-linear conversion characteristic is a monotonically increasing function and the pooling process is only the maximum value pooling process is satisfied, since the non-linear processing may be performed on one data after the pooling processing, the circuit scale can be further reduced.

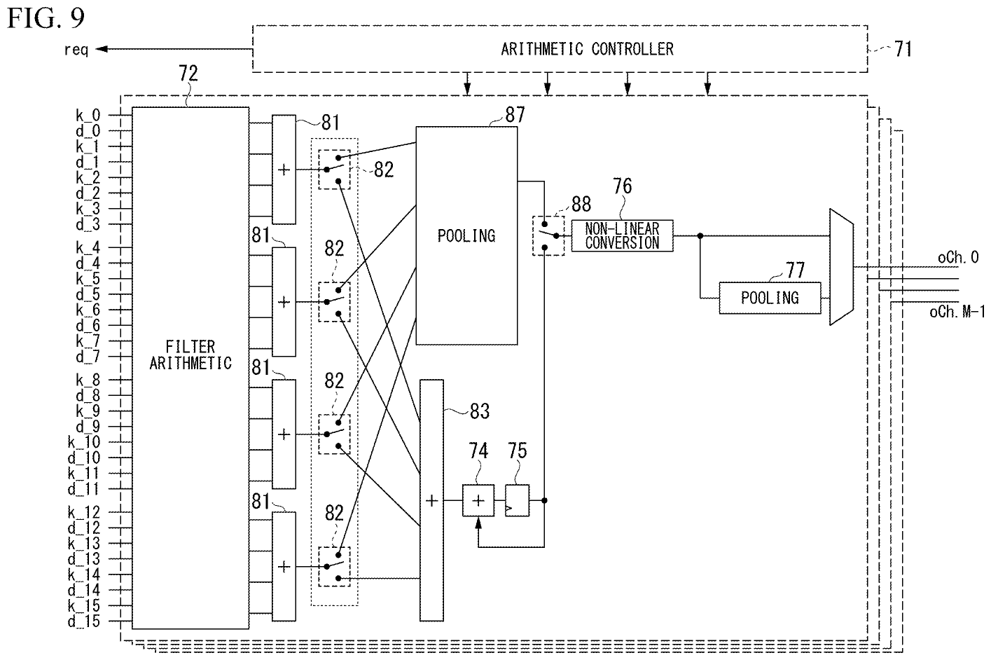

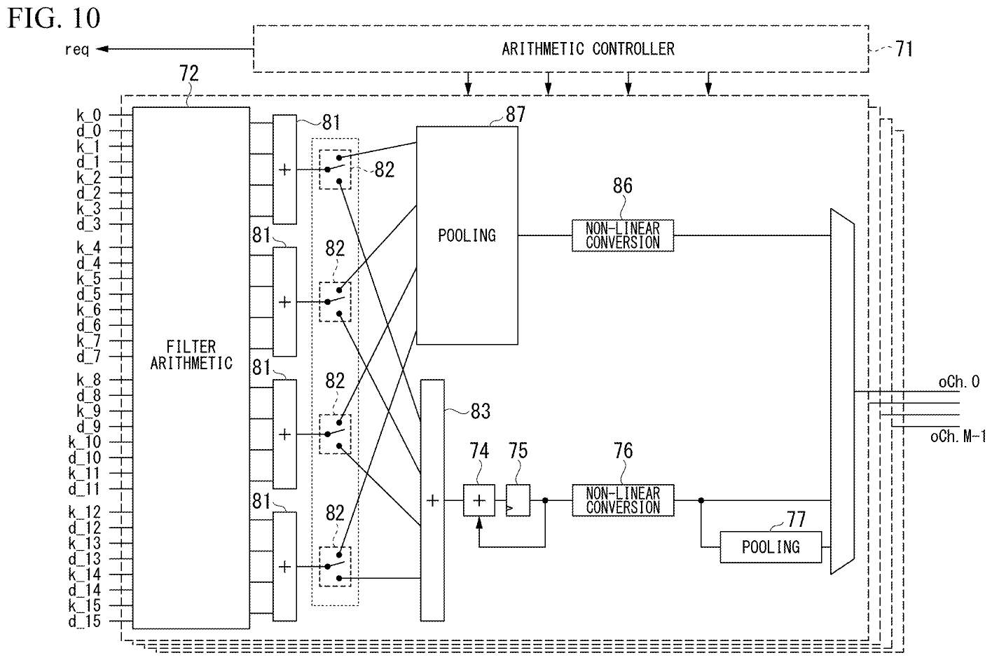

FIGS. 9 and 10 are diagrams showing the configuration of the arithmetic part 7 in which the order of the non-linear arithmetic processing and the pooling processing is exchanged in this way. In FIG. 9, the order of the pooling processing (second pooling processing part 87) of the parallel processing side path and the non-linear conversion is changed. Further, the non-linear converter 76 on the normal processing side is shared by the parallel processing and the normal processing by utilizing the fact that the parallel processing side path and the normal processing side path operate exclusively. Specifically, the output of the second pooling processing part 87 on the parallel processing side and the output of the FF75 on the normal processing side are switched by the selector 88 and input to the non-linear converter 76. With such a configuration, the processing speed is quadrupled by increasing the maximum value extraction circuit by one.

When the non-linear converter 76 is not shared, it is sufficient to exchange the order of the second non-linear converter 86 and the second pooling processing part 87 in FIG. 3 for example, and provide the second non-linear converter 86 after the second pooling processing part 87 as shown in FIG. 10.

### (Modified Example of Pooling Process)

Since the method described above satisfies “input parallelism N≥iFM number×pooling size”, it can be executed in parallel. However, if the number of iFMs increases a little and becomes “input parallelism N<number of iFMs×pooling size”, it cannot be dealt with. For example, when N=16 and the number of iFMs=8 (pooling size is 2×2), 16<8×2×2=32, which cannot be dealt with by the method described above, and parallel execution is impossible. However, by executing the pooling processing in several cycles in the vertical direction and the horizontal direction instead of performing the pooling process at one time, parallel execution is possible even in the case of “input parallel degree N<iFM number×pooling size”.

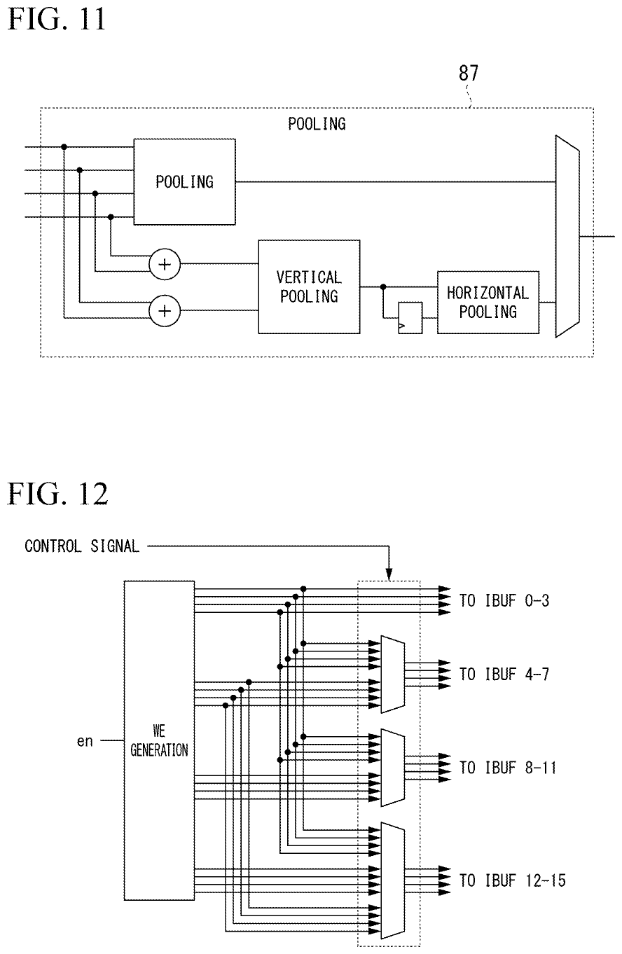

FIG. 11 is a diagram Showing a configuration of a second pooling processing part 87 when the pooling processing is performed separately in the vertical direction and the horizontal direction with respect to the scanning direction. It is assumed that the configuration of the entire arithmetic part 7 is as shown in FIG. 9.

When the number of iFMs≤4 (generally the pooling size k), the pooling processing passes through the upper path in the second pooling processing part 87 shown in FIG. 11, and the same pooling processing, as the method described above is performed.

When 4<iFM number≤8, the pooling processing passes through the lower path in the second pooling processing part 87 of FIG. 11. That the pooling processing is performed separately in the vertical direction and the horizontal direction with respect to the scanning direction. The data to be input at the same time is only one of the vertical direction and the horizontal direction, and all the data necessary for the pooling processing is input over several cycles. The vertical pooling processing and the horizontal pooling processing are each executed at the timing when the trigger signal is input. The arithmetic controller 71 outputs a trigger signal for executing the vertical pooling processing and the horizontal pooling processing at a preset timing.

The four input ports of the second pooling processing part 87 are the addition results for FM4 surfaces, and since two of them are added, the two ports immediately before the vertical pooling processing are the addition results for the FM8 surfaces. By pooling in the vertical and horizontal directions with such a configuration, it is possible to execute two FMs in parallel for up to eight FM surfaces.

When 4<the number of iFMs≤8, the data of IBUF 0 to 7 is duplicated in IBUF 8 to 15, so it is necessary to add additional structures to the IBUF manager 5. FIG. 12 is a diagram showing in detail the “we” generation portion of the IBUF manager 5.

In FIG. 11, when the pooling processing is the maximum value pooling, the maximum value is extracted by both the vertical pooling processing part and the horizontal pooling processing part. When the pooling processing is an average value pooling, the vertical pooling processing part horizontal pooling processing part produces two addition results, but by finally dividing by 4 (2-bit shift), the horizontal pooling processing part can obtain the average value.

### Second Embodiment

A second embodiment of the present invention will be described. In the first embodiment, it is proposed to increase the processing speed of CNN by effectively utilizing the part that is not used as a circuit. In the second embodiment, the processing time is shortened by avoiding the redundant processing that occurs in the sixth layer of Yoro_tiny:v2, which is one of the variations of the CNN. In the second embodiment, the processing in the second pooling processing part 87 is different from that in the first embodiment, and the other basic configurations are the same as those in the first embodiment. Therefore, only the processing in the second pooling processing part 87 will be described below.

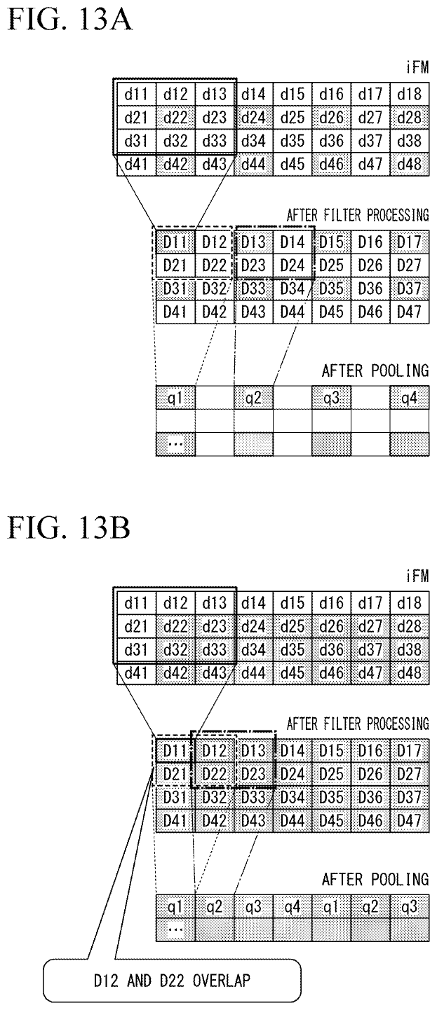

FIGS. 13A and 13B are diagrams showing the FM processing when the kernel size of the filter processing is 3×3 and the pooling processing part is 2×2. FIG. 13A shows a normal pooling processing, and the amount of movement of the center of gravity is 2 (stride=2). FIG. 13B shows the pooling process in the sixth layer of Yoro_tiny_v2, and the amount of movement of the center of gravity 1 (stride=1).

Normally, as shown in FIG. 13A, the iFM is processed so as not to overlap when viewed in the filtered result. Since the pooling processing part is 2×2. the iFM is output in half the vertical and horizontal sizes by the pooling processing. This is a movement on the premise that the center of gravity of the pixel during the pooling processing moves in units of 2 pixels, which is the same as the unit of the pooling processing. The amount of movement of the center of gravity is set by a parameter called stride, and in this example, stride=2.

The problem is that there may be a stride=1 in the setting, and in fact, in Yoro_tiny_v2, the stride=1 in the 6th layer. The operation when stroke=1 is as shown in FIG. 13B, and overlap occurs in the result after the filtering processing. Therefore, the filtering processing itself is executed several times for the same data, which leads to a decrease in processing time.

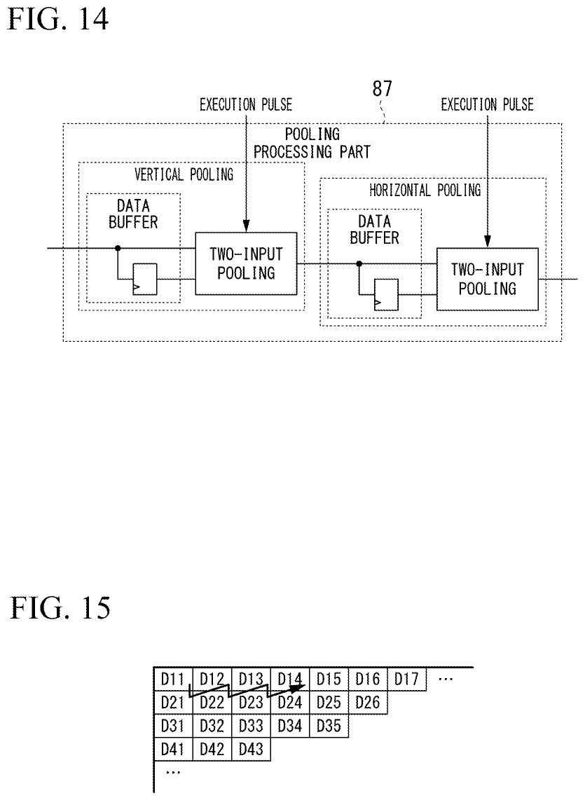

In the present embodiment, in order to solve this problem, the pooling processing is divided into the vertical direction and the horizontal direction, and execution pulses are given separately. FIG. 14 is a diagram showing the configuration of the second pooling processing part 87 of the present embodiment. Separately in the vertical direction and the horizontal direction with respect to the scanning direction of the process, each of them receives an execution pulse from the arithmetic controller and operates so as to execute the pooling processing. That is, each of the vertical pooling processing part that performs the vertical pooling processing and the horizontal pooling processing part that performs the horizontal pooling processing performs the pooling processing at the timing when the trigger (execution pulse) is input. The arithmetic controller 71 outputs a trigger signal for executing the horizontal pooling processing and the vertical pooling processing at a preset tinting.

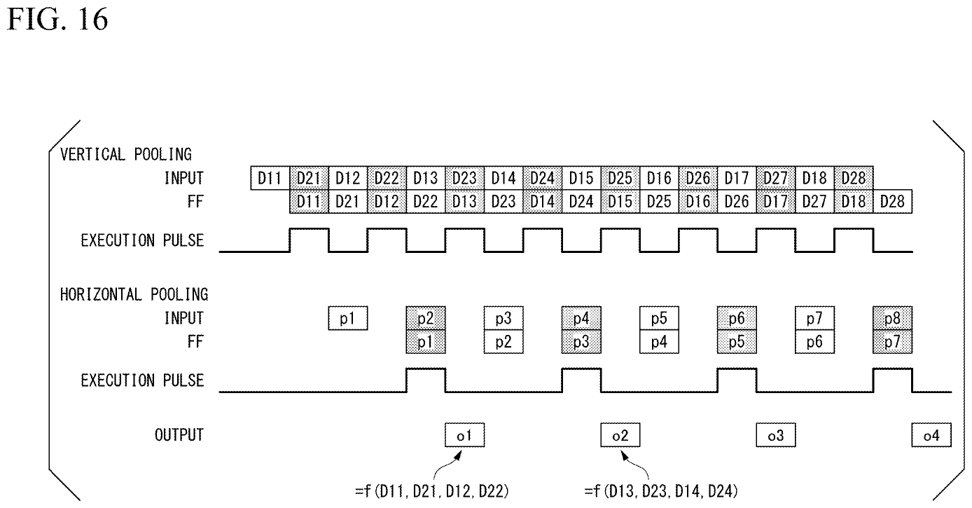

Specifically, the pooling processing is performed as follows. FIG. 15 is a diagram showing a pixel image of FM after non-linear conversion (after filtering). FIG. 16 is a diagram showing an execution waveform of the second pooling processing part 87 when the operation direction is the horizontal direction in the normal pooling processing (stride=2). As shown in FIG. 16, the iFM data shown in FIG. 15 are sequentially input to the second pooling processing part 87, and the pooling processing is sequentially executed.

In the pooling processing, the maximum value is taken in the case of maximum value pooling, and in the case of average value pooling, input data is added and divided by the number of pixels when all are completed. For example, in FIG. 16, for the vertical pooling result p1, the larger of D11 and D21 is selected in the case of maximum value pooling, and. D11+D21 is calculated in the case of average value pooling. For the horizontal pooling result o1, the larger of p1 and p2 is selected in the case of maximum value pooling, and (p1+p2)+4 is calculated in the case of average value pooling.

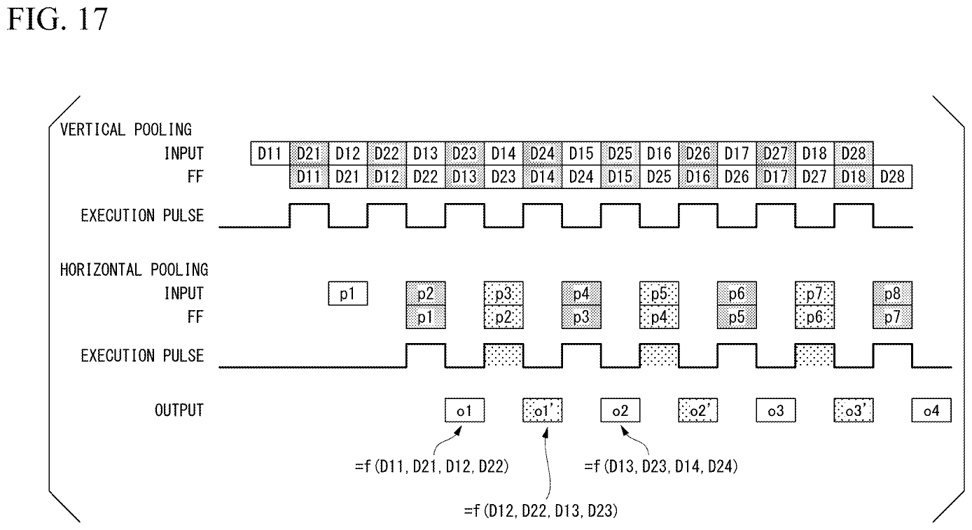

FIG. 17 is a diagram show ng an execution Waveform of the second pooling processing part 87 when the operation direction is horizontal When stroke=1. Compared with FIG. 16, the execution pulse interval of horizontal pooling is halved.

In this way, pooling can be executed in a pipeline processing even when stride=1. In addition, by separating the vertical pooling processing and horizontal pooling processing, the number of data to be processed at one time is reduced, so the number of FFs for waiting can be reduced, the circuit for the maximum value calculation (or total addition) can also be made smaller, and the circuit scale can be made smaller.

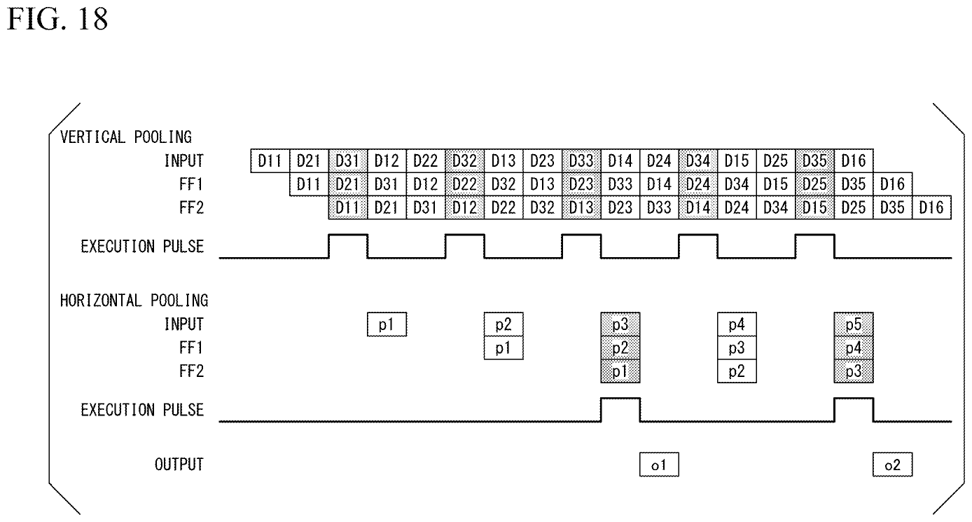

Further, if the pooling processing is controlled in this way, it is necessary to add a waiting FF or the like even for a complicated setting such as a pooling size of 3×3 and a stride=2, but this can be easily dealt with. FIG. 18 is a diagram showing an execution waveform of the second pooling processing part 87 when the pooling size is 3×3 and stride=2.

When stride=1, it is possible to install a line memory to hold the vertical pooling result in order to avoid vertical overlap, but a memory for one line is required. Since the line memory defines the upper limit of the FM size, it is not installed in this specification in consideration of the correspondence to a new network to be devised in the future, but such improvement is possible if there is no problem. In this case, the line memory and its control are only added, so the illustration is omitted.

### Third Embodiment

A third embodiment of the present invention will be described. In the first embodiment, when there is an unused circuit on the input side of the arithmetic part, a method of effectively utilizing the unused portion is proposed, but the third embodiment relates to a method fur effectively utilizing an unused portion when there is an unused circuit on the output side of the arithmetic part.

As a basic operation of the arithmetic part, one oFM is generated by inputting all iFMs but one oFM may be generated by sharing it among a plurality of output channel groups. When the output parallel degree is M and, for example, the number of oFMs=M/2, one oFM can be shared and generated by two output channel groups.

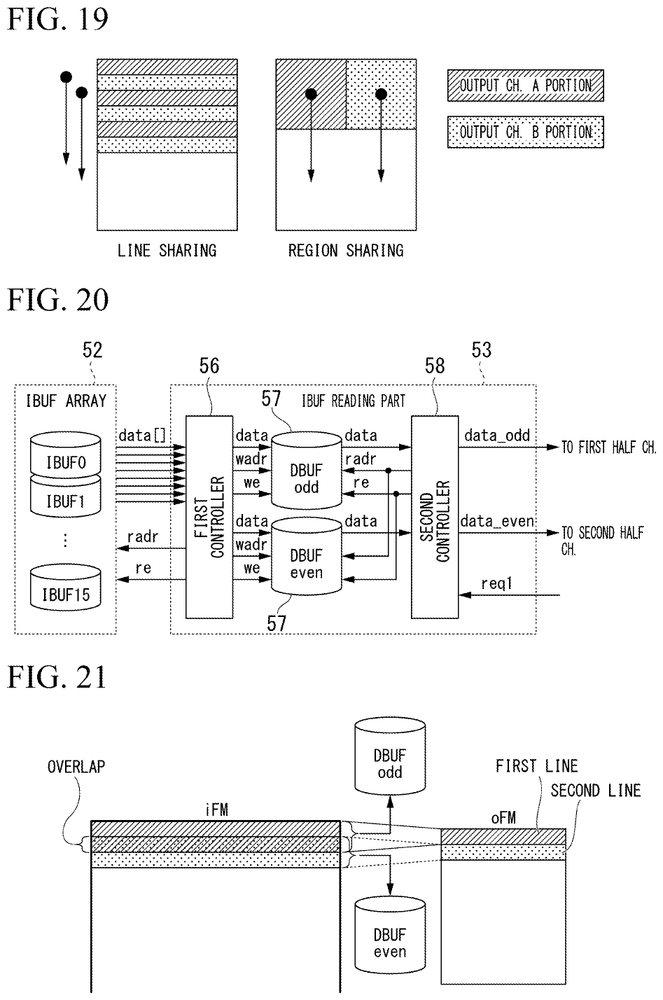

FIG. 19 is an image diagram in which two output channel groups (output channel A and output channel B) are shared to generate one oFM. As a method of sharing b two output channel groups, the left figure of FIG. 19 shows an example (line sharing) of sharing oFM in line units (odd line and even line), and the right figure of FIG. 19 shows an example (region sharing) in which the oFM is divided into left and right regions and shared. Similarly, when the degree of output parallelism is M and the number of oFMs is ≤M/2, one oFM can be divided into a plurality of regions, and each region can be shared and processed by a plurality of output channel groups.

Such processing can be easily handled by appropriately setting the data read address in the IBUF read unit 53. However, one oFM data is output by combining the outputs from the two different output channel groups. Therefore, it is necessary to define a format that can integrate the outputs from two different output channel groups so that the input in the next layer becomes one FM data.

In the following description, as shown in the left figure of FIG. 19, the case where the odd-numbered lines and the even-numbered lines of the oFM are shared and processed by the two output channel groups will be described as an example. However, the number of output channel groups sharing one oFM is not limited to two, and may be shared by three or four output channel groups.

FIG. 20 is a diagram showing a configuration on the output side of the IBUF (data storage memory) manager 5 of the present embodiment. When reading data from IBUF in the IBUF-reading part 53, it is necessary to separately prepare data for odd-numbered lines and data, for even-numbered lines. Therefore, a DBUF 57 (second data storage memory) for temporarily storing the data is prepared, and the data is first transferred from the IBUF to the DBUF. The first controller 56 in the previous stage of the DBUF 57 divides the oFM into a plurality of regions, extracts data necessary for processing each region, and writes the data in the DBUF 57. The data for odd-numbered lines is stored in DBUFodd, and the data for even-numbered lines is stored in DBUFeven.

Here, by letting the degree of output parallelism be M, it is assumed that, among M output channels oCh. 0 to oCh. (M-1), output channel oCh. 0 to oCh. (2/M-1) belongs to the output channel group in the first half and output channel oCh. (2/M-1) to oCh. (M-1) belongs to the output channel group in the second half. Then, it is assumed that the output channel group in the first half processes the odd-numbered lines of oFM, and the output channel group in the second half processes the even-numbered lines of oFM.

The IBUF-reading part 53 transfers the data stored in the DBUFodd to the output channel group in the first half as data (data_odd) required for odd-numbered line processing. Similarly, the IBUF-reading part 53 transfers the data stored in the DBUFeven to the output channel group in the second half as data (data_even) required for even-numbered line processing.

FIG. 21 is a diagram showing a data storage image in DBUFodd and DBUFeven. The iFM required to generate the first line of the oFM is the area of the first line and the second line on the iFM, and the iFM required to generate the second line of the oFM is the area of the second line and the third line on the iFM. That is, since there is an overlapping region on the iFM that portion is stored in both DBUFodd and DBUFeven.

In the subsequent stage of each DBUF 57 (second controller 58 in FIG. 20), the data required for generating the oFM1 pixel is sequentially read from the data stored in the DBUF 57. The second controller 58 controls to acquire data from the DBUF by a predetermined method. By this read control, data_odd is supplied to the output channel group in the first half, and data_even is supplied to the output channel group in the second half.

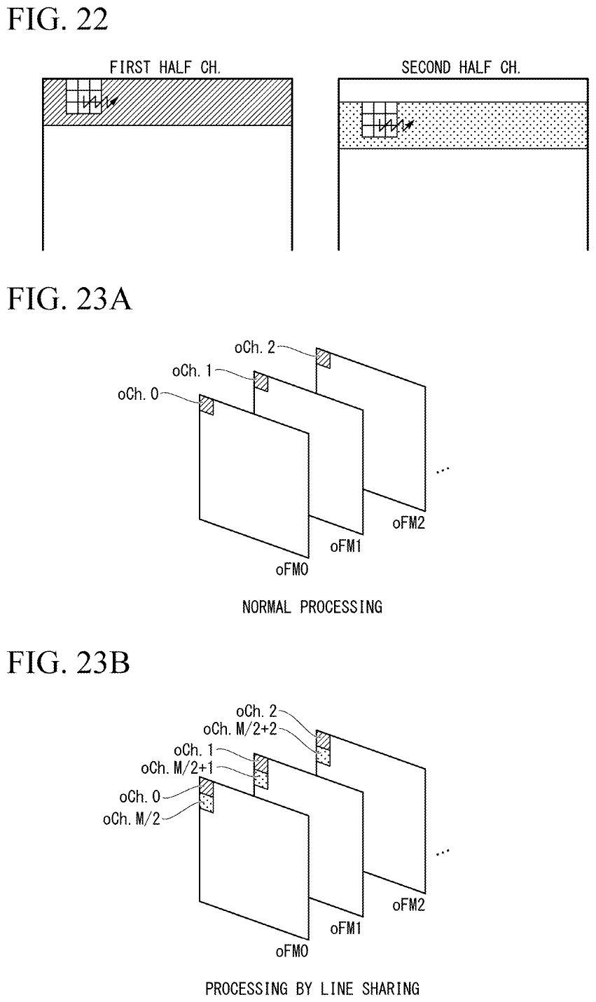

FIG. 22 is a diagram showing an image of the difference in position on the iFM processed by the two output channel groups. The left side of FIG. 22 shows the position to be processed by the output channel group in the first half, and the right side of FIG. 22 shows the position to be processed by the output channel group in the second half As shown in FIG. 22, it is possible to simultaneously process the region shifted by one line in the output channel group in the first half and the output channel group in the second half.

Next, the oFM data output via the arithmetic part in the above-described processing will be described. FIGS. 23A and 23B are image diagrams of oFM data output from the arithmetic part. FIG. 23A shows the case of normal processing, that is, the case where one oFM is processed by one output channel group. Assuming that the output parallelism is M, one oFM consists of M EMs (oFM0, oFM1, oFM2, . . . ), and data at the same position of each FM is output from M output channels (oCh.0, oCh.1, oCh.2, . . . ).

FIG. 23B shows a case where one oFM is processed by dividing the line between two output channel groups. As shown in FIG. 23B, the output channels (oCh.0, oCh.1, oCh.2, . . . , OCh.M/2−1) of the output channel group n the first half output the data at the same position of each FM. The output channels (oCh.M/2, oCh.M/2+1, oCh.M/2+2, . . . , OCh.M-1) of the output channel group in the second half output the data at the position shifted by one line of each FM. In this way, when processing is performed by line sharing, the output channel group in the first half and the output channel group in the second half output data at positions shifted by one line on the same oFM.

Since the format of the oFM data output from the two different output channel groups is input as one iFM in the next layer ((k+1)-th layer), an operation selection signal (mode) is input to the data input part 3 to switch the control during the processing of the (k+1)-th layer.

In the following description, for further simplification, the input parallel degree N=16, the output parallel degree M=16, and the number of oFM=M/2=8. In addition, D (k) is defined as the data output from oCh.k, and D0_16 is defined as the data concatenating the data (D (0) to D (16-1)) output from all oCh.

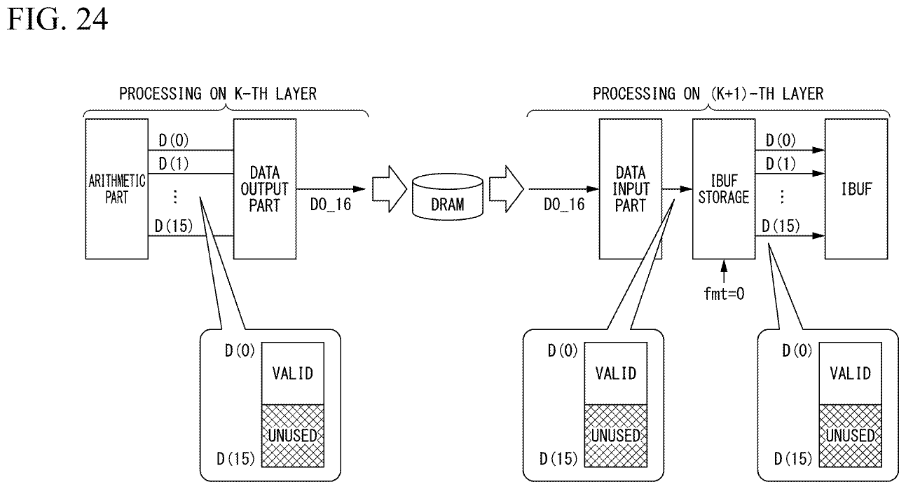

First, a case where normal processing, that is, sharing processing is not performed will be described. FIG. 24 is a diagram showing a flow from the processing of the k-th layer to the processing of the (k+1)-th layer during the normal processing, In FIG. 24, as for the output of the arithmetic part of the k-th layer, only the first half portion of D0_16 is valid, and the second half portion of D0_16 is in an unused state. D0_16 in this state is input to the (k+1)-th layer. If D0_16 can be acquired by one burst transfer, unused data, will be input, resulting in poor transfer efficiency

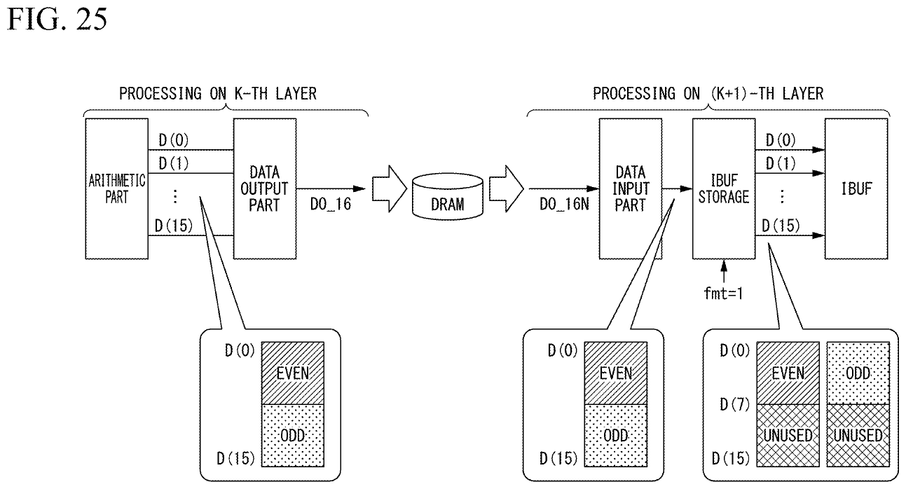

Next, the time of line-sharing processing will be described. FIG. 25 is a diagram showing a flow from the processing of the k-th layer to the processing of the (k+1)-th layer during the line-sharing processing. In D0_16N input to the (k+1)-th layer, the second half portion that was unused during normal processing also has the same iFM data (data at a position shifted one line below) as the first half portion. D0_16N stored in the IBUF storage is divided into two data and output to the IBUF separately.

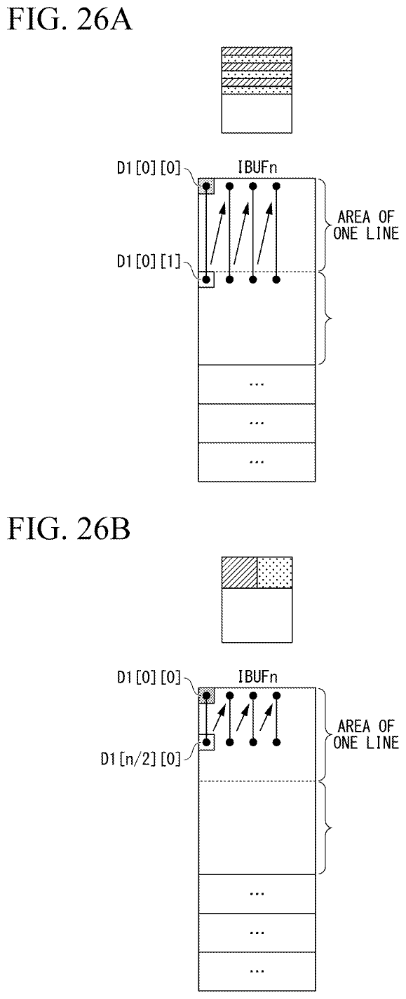

FIGS. 26A and 26B are diagrams showing images of writing specific data to IBUF. FIG. 26A shows the time of line-sharing processing, and FIG. 26B shows the time of area-sharing processing. As Shown in FIG. 26A, during the line-sharing processing, the addressing is performed so as to shift downward by one pixel. As shown in FIG. 26B, since the positional relationship is shifted by half of one line during the area-sharing processing, the addressing is also shifted by half a line.

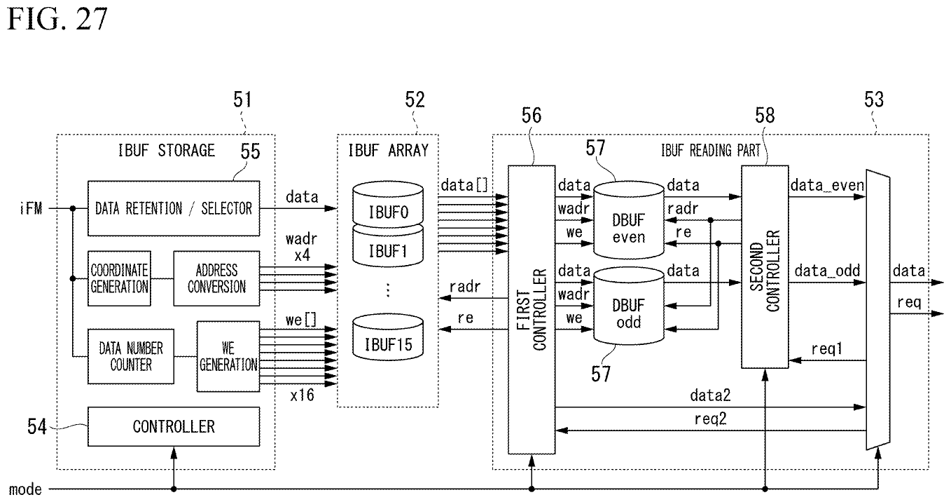

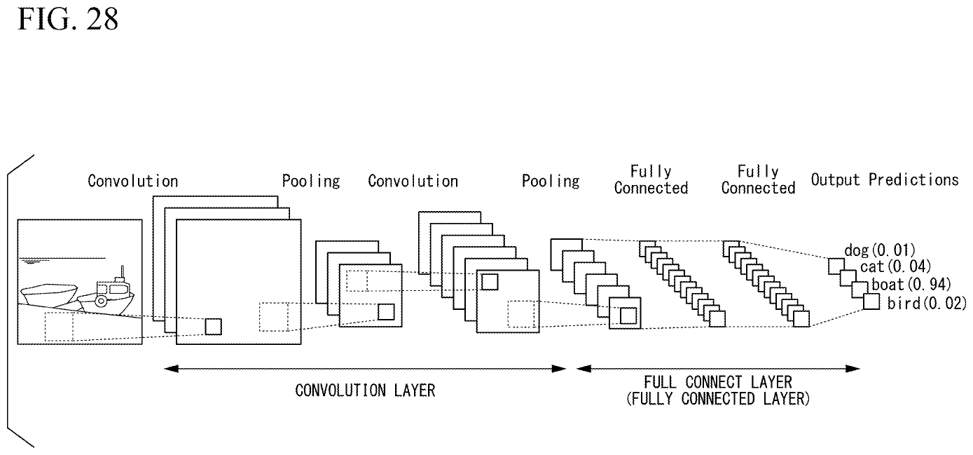

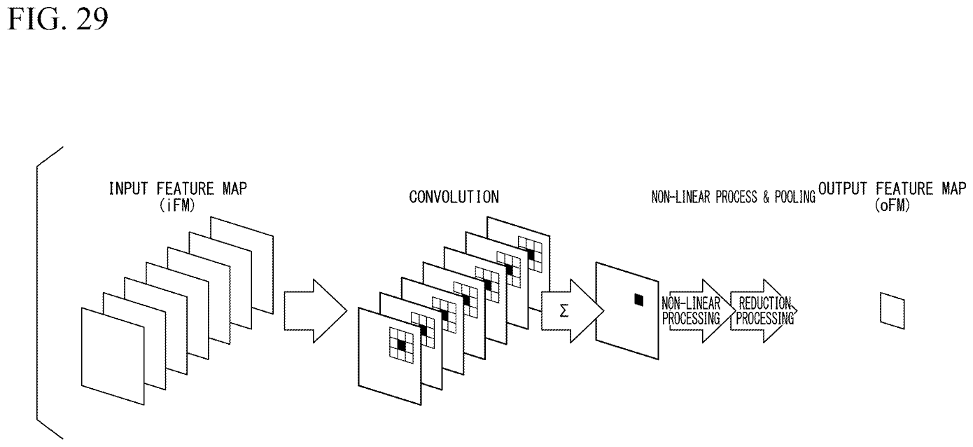

FIG. 27 is a diagram showing the overall configuration of the IBUF manager 5 of the present embodiment. In order to realize the above-mentioned processing, the IBUF storage 51 includes a controller 54 that determines the mode and changes the control, and a data retention/selector part 55. The controller 54 has a mode in which iFMs input in the same cycle are held and controlled so as to be divided into several cycles and written to the same IBUF. As a result, the processing can be parallelized and the execution time can be shortened when the number of oFMs≤M/2. Other than that, the configuration in the IBUF storage 51 is the same as that in FIG. 6. In addition, the IBUF-reading part 53 uses paths (data2, reg2) for directly extracting IBUF data without going through the DBUF 57 during normal processing.

With such a configuration, one FM can be simultaneously processed by a plurality of output channel groups, and the data can be restored at the time of input to the next layer, and the processing time can be increased.

Although one embodiment of the present invention has been described above, the technical scope of the present invention is not limited to the above-described embodiment, and the combination of components can be changed, various changes can be made to each component, and the components can be omitted without departing from the spirit of the present invention.

Each component is provided for explaining the function and processing related. to each component. One configuration (circuit) may simultaneously realize functions and processes related to a plurality of components.

Each component may be realized by a computer including one or more processors, a logic circuit, a memory, an input/output interface, a computer-readable recording medium, and the like, or as a whole. In that case, the above-described various functions and processes may be realized by recording a program for realizing each component or the entire function on a recording medium, loading the recorded pro gram into a computer system, and executing the program.

In this case, for example, the processor is at least one of a CPU, a DSP (Digital Signal Processor), and a GPU (Graphics-Processing Unit). For example, the logic circuit is at least one of ASIC (Application-Specific Integrated Circuit) and FPGA (Field-Programmable Gate Array).

Further, the “computer system” referred to here may include hardware such as an OS and peripheral devices. Further, the “computer system” includes a homepage-providing environment (or a display environment) if a WWW system is used. The “computer-readable recording medium” includes a writable non-volatile memory such as a flexible disk, a magneto-optical disk, a ROM, and a flash memory, a portable medium such as a CD-ROM, and a storage device such as a hard disk built into a computer system.

Further, the “computer-readable recording medium” also includes those that hold the program for a certain period of time, such as a volatile memory (for example, DRAM (Dynamic Random-Access Memory)) inside a computer system that Serves as a server or a client when a program is transmitted via a network such as the Internet or a communication fine such as a telephone line.

Further, the program may be transmitted from a computer system in which this program is stored in a storing part device or the like to another computer system via a transmission medium or by a transmission wave in the transmission medium. Here, the “transmission medium” for transmitting a program refers to a medium having a function of transmitting information, such as a network (communication network) such as the Internet or a communication line such as a telephone line. Further, the above program may be for realizing some of the above-described functions. Further, it may be a so-called difference file (difference program) that realizes the above-described function in combination with a program already recorded in the computer system.

The present invention can be widely applied to an arithmetic processing device that performs deep learning using a convolutional neural network.

What is claimed is:

1. An arithmetic processing device for deep learning that performs a convolution processing and a full-connect processing, the arithmetic processing device including a processor that auctions as:
a data-storing memory manager having a data-storing memory configured to store input feature amount map data and a data-storing memory controller configured to manage and control the data-storing memory;
a filter coefficient-storing memory manager having a filter coefficient-storing memory configured to store a filter coefficient and a filter coefficient-storing memory controller configured to manage and control the filter coefficient-storing memory;
an external memory configured to store the input feature map data and output feature map data;
a data input part configured to acquire the input feature amount map data from the external memory;
a filter coefficient input part configured to acquire the filter coefficient from the external memory;
an arithmetic part with a configuration in Which N-dimensional data is input, processed in parallel, and M-dimensional data is output (where N and M are positive numbers greater than 1), configured to acquire the input feature map data from the data-storing memory, acquire the coefficient from the coefficient-storing memory, and perform a filter processing, a cumulative addition processing, a non-linear arithmetic processing, and a pooling processing:
a data output part configured to convert the M-dimensional data output from the arithmetic part to output as output feature map data to the external storing memory; and
a controller configured to control the arithmetic processing device,
wherein the arithmetic part functions as
a filter arithmetic part configured to perform a filter arithmetic on the N-dimensional data in parallel,
k first adders configured to cumulatively add NI arithmetic results of the filter arithmetic part,
a selector provided after each first adder, the selector being configured to branch output of the first adder and to switch between a first processing side and a second processing side,
a second adder configured to cumulatively add cumulative addition results of k first adders in a case where the selector branches to the first processing side,
a third adder configured to cumulatively add cumulative addition results of the second adder in a subsequent stage,
a first non-linear converter configured to perform non-linear arithmetic processing on cumulative addition results of the third adder,
a first pooling processing part configured to perform pooling processing on processing results of the first non-linear converter,
a second non-linear converter configured to perform non-linear arithmetic processing on cumulative addition results of the first adder in a case where selector branches to the second processing side,
a second pooling processing part configured to input cumulative addition results of the k first adders that have been non-linearly processed by the second non-linear converter and to perform pooling processing on simultaneously input data, and
an arithmetic controller configured to control the arithmetic part,
in a case where the number of the input feature amount map data input to the arithmetic part≤N/k, the data storing memory manager is configured to write the same data, to k different data storage memories, and
in a case where the number of the input feature amount nap data≤N/k, the arithmetic controller is configured to control the selector to branch to the second processing side.

2. The arithmetic processing device according to claim 1, wherein, in the first mode,
the data storage memory controller is configured
to control to write the same data to the same address of k different data storage memories when writing to the data storage memory and
to classify the data storage memory into k groups of N/k, to control to access addresses that are vertically and or horizontally offset by several pixels by changing the addresses in each group at a time of reading from the data storage memory.

3. The arithmetic processing device according to claim 1, wherein, in the second mode,
the data storage memory controller is configured
to control to write the same data to addresses that are shifted by several pixels in the vertical and/or horizontal directions in k different data storage memories at a time of writing to the data storage memory, and
to access all the data storage memories at the same address at a time of reading from the data storage memory.

4. An arithmetic processing device for deep learning that performs a convolution processing and a full-connect processing, the arithmetic processing device including a processor that functions as:
a data-storing memory ma ager having a data-storing memory configured to store input feature amount map data and a data-storing memory controller configured to manage and control the data-storing memory;
a filter coefficient-storing memory manager having a filter coefficient-storing memory configured to store a filter coefficient and a filter coefficient-storing memory controller configured to manage and control the filter coefficient-storing memory;
an external memory configured to store the input feature map data and output feature map data;
a data input part configured to acquire the input feature amount map data from the external memory;
a filter coefficient input part configured to acquire the filter coefficient from the external memory;
an arithmetic part with a configuration in which N-dimensional data is input, processed in parallel, and M-dimensional data is out (where N and M are positive numbers greater than 1), configured to acquire the input feature map data from the data-storing memory, acquire the coefficient from the coefficient-storing memory, and perform a filter processing, a cumulative addition processing, a non-linear arithmetic processing, and a pooling processing;
a data output part configured to convert the M-dimensional data output from the arithmetic part to output as output feature map data to the external storing memory; and
a controller configured to control the arithmetic processing device,
wherein the arithmetic part functions as
a filter arithmetic part configured to perform a filter arithmetic on the N-dimensional data in parallel,
k first adders configured to cumulatively add NI Arithmetic results of the filter arithmetic
a selector provided after each first adder, the selector being configured to branch output of the first adder and to switch between a fast processing side and a second processing side,
a second adder configured to cumulatively add cumulative addition results of k first adders in a case where the selector branches to the first processing side,
a third adder configured to cumulatively add cumulative addition results of the second adder in a subsequent stage,
a first non-linear converter configured to perform non-linear arithmetic processing on cumulative addition results of the third adder,
a first pooling processing part configured to perform pooling processing on processing results of the first non-linear converter,
a second pooling processing part configured to perform pooling processing on cumulative addition results of the first adder when the selector branches to the second processing side,
a second non-linear converter provided after the second pooling processing part, the second non-linear converter being configured to perform non-linear arithmetic processing on cumulative addition results of the first adder that has been subjected to the pooling processing by the second pooling processing part, and
an arithmetic controller configured to control the arithmetic part,
in a case where the number of the input feature amount map data input to the arithmetic part≤N/k, the data-storing memory manager is configured to write the same data, to k different data storage memories, and
in a case where the number of the input feature amount map data≤N/k, the arithmetic controller is configured to control the selector to branch to the second processing side.

5. The arithmetic processing device according to claim 4, wherein the first non-linear converter and the second linear converter have the same configuration and are shared by the first processing side and the second processing side.

6. The arithmetic processing device according to claim 1, wherein
the second pooling processing part is configured to perform pooling processing separately in a vertical direction and a horizontal direction with respect to a scanning direction,
a pooling processing in the vertical direction and a pooling processing in the horizontal direction are each executed at a timing when a trigger signal is input, and
the arithmetic controller is configured to output the trigger signal at a preset timing.
